(19) United States
(12) Patent Application Publication
(10) Pub. No.: US 2023/0225287 A1
(43) Pub. Date: Jul. 20, 2023

(54) VARIABLE-CAPACITY PET FEEDER

(71) Applicant: YIZHUO YU, SHENZHEN CITY (CN)

(72) Inventor: YIZHUO YU, SHENZHEN CITY (CN)

(21) Appl. No.: 17/673,130

(22) Filed: Feb. 16, 2022

(30) Foreign Application Priority Data
Jan. 17, 2022 (CN) 202220130528.0

(51) Int. Cl. A01K 5/01; A01K 5/02

(52) U.S. Cl. CPC A01K 5/0135; A01K 5/0225

(57) ABSTRACT

The present invention provides a variable-capacity pet feeder, relating to the technical field of pet feeders. The pet feeder includes: an accommodating bucket; a discharge assembly, where the discharge assembly communicates with the accommodating bucket; and expansion buckets, where a plurality of expansion buckets are provided, the plurality of expansion buckets are disposed at an end of the accommodating bucket away from the discharge assembly, and the expansion buckets communicate with the accommodating bucket. One detachment member is disposed at each of joints of adjacent expansion buckets and the accommodating bucket. The detachment member includes a clamping block and a clamping slot for clamping the clamping block. According to the foregoing technical solution, the variable-capacity pet feeder has the advantages of having an arbitrarily variable feeder capacity, facilitating food storage convenience, and being easy to change, simple and practical.

### FIELD OF THE DISCLOSURE

The present invention relates to the technical field of pet feeders, and in particular, to a variable-capacity pet feeder.

### BACKGROUND OF THE DISCLOSURE

With the continuous improvement of residents' living standards, a growing number of domestic urban residents keep pets. Pets have become indispensable good companions for many old people, children and even workers, and also become people's spiritual ballast to relax. However, in real life, since no special person takes care of or feeds pets in most of families, pet owners' going out early and coming home late makes pets have to eat in a hurry only in the morning and in the evening but have nothing to eat when they are hungry at home. It is convenient to buy pets, but raising pets is not an easy task. Especially when people go out for business or tourism, they usually cannot take timely and good care of pets at home, so feeding pets has become an outstanding problem that puzzles people. Therefore, automatic pet feeders have emerged.

However, existing pet feeders generally have an invariable capacity, so that a user can only buy an invariable-capacity pet feeder and store pet food in the invariable-capacity pet feeder during use, causing inconvenience to food storage.

### SUMMARY OF THE DISCLOSURE

In view of the defects and deficiencies in the prior art, an objective of the present invention is to provide a variable-capacity pet feeder, which has the advantages of having an arbitrarily variable feeder capacity, facilitating food storage convenience, and being easy to change, simple and practical.

To implement the foregoing objective, the technical solution of the present invention is as follows: A variable-capacity pet feeder includes: an accommodating bucket; a discharge assembly, where the discharge assembly communicates with the accommodating bucket; and expansion buckets, where a plurality of expansion buckets are provided, the plurality of expansion buckets are disposed at an end of the accommodating bucket away from the discharge assembly, and the expansion buckets communicate with the accommodating bucket.

One detachment member is disposed at each of joints of adjacent expansion buckets and the accommodating bucket.

The detachment member includes a clamping block and a clamping slot for clamping the clamping block.

The discharge assembly includes: a food guide base, where the food guide base is disposed at the bottom of the accommodating bucket; and a discharge member, where the discharge member is disposed in the food guide base, a discharge frame communicating with the accommodating bucket is disposed on the discharge member, and the discharge member is configured to control food in the accommodating bucket to fall or stop falling.

A connector is disposed between the discharge assembly and the accommodating bucket.

The discharge member includes: a partition plate, where the partition plate is fixedly disposed in the food guide base, a second food leaking hole and a through-hole are provided in the partition plate; a motor fixedly disposed at the bottom of the partition plate, where an output shaft of the motor penetrates through the through-hole; and a rotation plate, where one side of the rotation plate is fixedly disposed at an end of the discharge frame away from the accommodating bucket, the other side of the rotation plate is closely attached to the partition plate, the rotation plate is connected to the output shaft of the motor, a first food leaking hole that corresponds to the second food leaking hole is provided in the rotation plate, an annular groove is provided in an outer edge of the partition plate, the rotation plate is rotationally disposed in the annular groove, and a diameter of the rotation plate is greater than or equal to a diameter of the discharge frame and less than a diameter of the annular groove.

The output shaft of the motor and the rotation plate are detachably assembled.

An upper cover is disposed at the top of the accommodating bucket or on the expansion bucket.

A food dish is disposed at the bottom of the food guide base, and the food dish is concave inward. The food dish is disposed on a side of the food guide base. A food guide plate is disposed on a side face of the food guide base. One end of the food guide plate is disposed below a discharge portion of the discharge assembly, and the other end of the food guide plate is disposed above the food dish.

The food dish and the food guide base are detachably assembled.

After the foregoing technical solution is applied, the present invention has the beneficial effects as follows.

1. The discharge assembly communicates with the accommodating bucket, a plurality of expansion buckets are provided, the plurality of expansion buckets are detachably stacked at an end of the accommodating bucket away from the discharge assembly, and the expansion buckets communicate with the accommodating bucket. With such an arrangement, the variable-capacity pet feeder effectively resolves the defect that existing pet feeders generally have an invariable capacity, so that a user can only buy an invariable-capacity pet feeder and store pet food in the invariable-capacity pet feeder during use, causing inconvenience of food storage, and has the advantages of having an arbitrarily variable feeder capacity, facilitating food storage convenience, and being easy to change, simple and practical.

2. The food dish is disposed at the bottom of the food guide base, and the food dish is concave inward so as to contain pet food. A boss is fixedly disposed at the lowest point in the food dish, and a side face of the boss is an inclined face, so that the pet food effectively slides into the food dish. An end of the boss away from the food dish is connected to the food guide base, a discharge port is provided in a side face of the food guide base, and the discharge port is located at a joint of the food guide base and the boss. The pet food slides into the food dish along the discharge port by using the food guide base and is prevented from easily falling out of the food dish.

### BRIEF DESCRIPTION OF THE DRAWINGS

To illustrate the technical solutions in the embodiments of the present invention or in the prior art more clearly, the following briefly describes the accompanying drawings required for describing the embodiments or the prior art. Apparently, the accompanying drawings in the following description show merely some embodiments of the present invention, and a person of ordinary skill in the art may still derive other accompanying drawings from these accompanying drawings without creative efforts.

FIG. 1 is a schematic structural diagram according to the present invention;

FIG. 2 is an exploded view that corresponds to FIG. 1;

FIG. 3 is a schematic structural diagram of a first part according to the present invention; and

FIG. 4 is a schematic structural diagram of a second part according to the present invention.

### DETAILED DESCRIPTION OF THE EXEMPLARY EMBODIMENTS

The following further describes the present invention in detail with reference to the accompanying drawings.

This specific embodiment is merely for illustration of the present invention, but not intended to limit the present invention. After reading this specification, a person skilled in the art can make modifications without creative contribution to this embodiment as desired, but such modifications shall all be protected by Patent Law without departing from the scope of the claims of the present invention.

### Embodiments

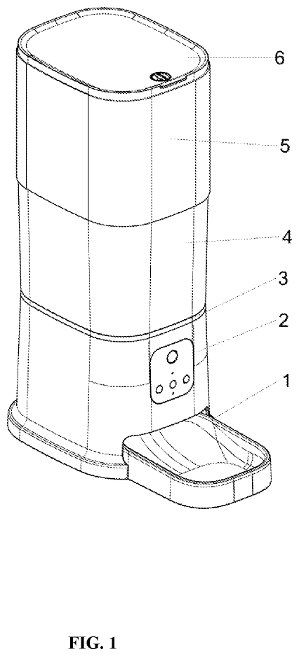

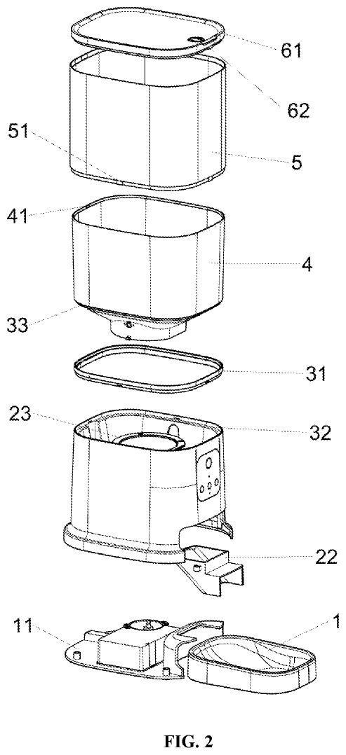

This embodiment relates to a variable-capacity pet feeder. As shown in FIG. 1 and FIG. 2, the pet feeder includes: a discharge assembly 2, expansion buckets 5, an accommodating bucket 4, and detachment members.

The discharge assembly 2 communicates with the accommodating bucket 4. The discharge assembly 2 is configured to control food in the accommodating bucket 4 to fall or stop falling. A plurality of expansion buckets 5 are provided. Clamping slots 41 are provided on the tops of the expansion buckets 5 and the top of the accommodating bucket 4. One detachment member is disposed at each of joints of adjacent expansion buckets 5 and the accommodating bucket 4. The detachment member includes a clamping block 51 and the clamping slot 41 for clamping the clamping block 51. The clamping blocks 51 are disposed at the bottom of the expansion bucket 5. Between the expansion buckets 5 or between the expansion bucket 5 and the accommodating bucket 4, through the cooperation of the clamping blocks 51 and the clamping slots 41, the expansion buckets 5 communicate with the accommodating bucket 4, so that the expansion buckets 5 are detachably stacked at an end of the accommodating bucket 4 away from the discharge assembly 2, to implement an expansion function. In this embodiment, an upper cover 6 is disposed at the top of the accommodating bucket 4 or on the expansion bucket 5, an insertion part 62 is disposed on the upper cover 6, and the insertion part 62 is a detachment member, so that the upper cover 6 can cover the accommodating bucket 4 or cover the stacked expansion buckets 5, to improve sealing performance of the entire apparatus and implement effects of preventing dust, insects and dampness. The discharge assembly 2 is intelligently controlled and can start to spread food regularly and can also control the amount of spread food. In other embodiments, the discharge assembly 2 is manual. A telescopic apparatus is disposed between the expansion bucket 5 and the accommodating bucket 4. The telescopic apparatus is configured to increase or decrease a size of a space between the expansion bucket 5 and the accommodating bucket 4, to implement an expansion function. The telescopic apparatus may be a manually stretched or electric pull rope.

Preferably, the connector 3 includes: a clamping ring 31, a first clamping part 32, and a second clamping part 33. The clamping ring 31 is provided with a plurality of clamping blocks, the first clamping part 32 is disposed on a side of the discharge assembly 2 close to the clamping ring 31, the first clamping part 32 and the clamping blocks are detachably assembled, and the second clamping part 33 is disposed on the accommodating bucket 4 and detachably assembled with the clamping blocks on the other side of the clamping ring 31, so that the accommodating bucket 4 can be detached to facilitate cleaning or replacement. When this apparatus is not used for a long time, the accommodating bucket 4 can be detached and cleaned, and the accommodating bucket 4 can serve as a food storage bucket to store the pet food after being detached, to implement multiple functions.

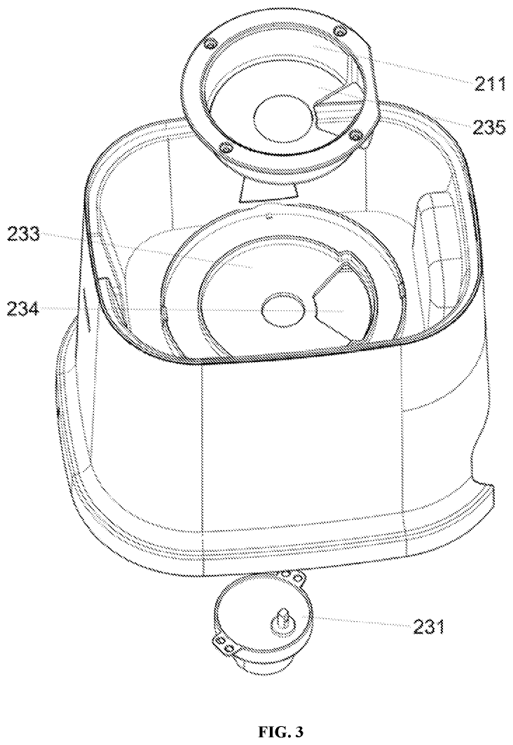

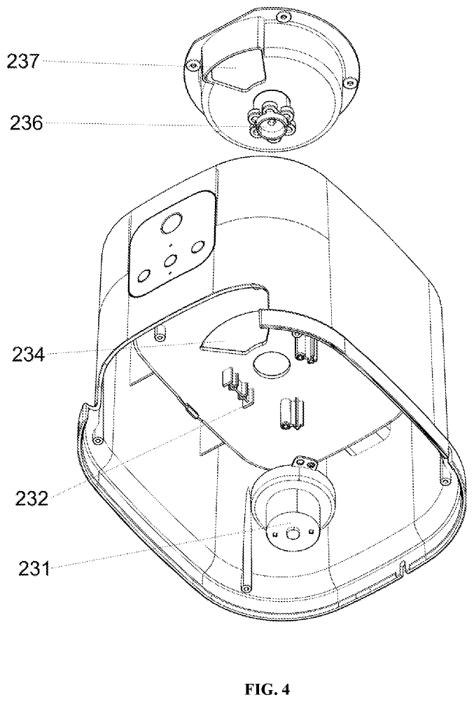

Preferably, as shown in FIG. 2, FIG. 3, and FIG. 4, the discharge assembly 2 includes: a food guide base 21 and a discharge member.

The food guide base 21 is disposed at the bottom of the accommodating bucket 4. A discharge frame 211 communicating with the accommodating bucket 4 is disposed on the food guide base 21. The discharge member is disposed in the food guide base 21. The discharge member is configured to control food in the accommodating bucket 4 to fall or stop falling. In this embodiment, the food guide base 21 and the accommodating bucket 4 are detachably assembled, so that this apparatus is convenient to detach, clean, and replace. A base is disposed at the bottom of the food guide base 21. The base 11 is configured to support the entire apparatus. A food guide plate 22 is disposed on a side face of the food guide base 21. The food guide plate 22 is inclined, with a higher end disposed below a discharge position of the discharge assembly 2. A food dish 1 is disposed on the food guide base 21 in an oblique direction, and the food dish 1 is concave inward and configured to accommodate the pet food. A lower end of the food guide plate 22 faces toward the food dish 1. The pet food slides into the food dish 1 by using the food guide base 21 and is prevented from easily falling out of the food dish 1.

Preferably, the discharge member includes: a partition plate 233, a motor 231, and a rotation plate 235.

The partition plate 233 is fixedly disposed in the discharge frame 211. The partition plate 233 is fixedly disposed in the food guide base 21. A first food leaking hole 234 and a through-hole are provided in the partition plate 233 and fixedly provided at the bottom of the partition plate 233. An output shaft of the motor 231 penetrates through the through-hole. One side of the rotation plate 235 is fixedly disposed at an end of the discharge frame 211 away from the accommodating bucket 4, and the other side of the rotation plate 235 is closely attached to the partition plate 233. The rotation plate 235 is connected to the output shaft of the motor 231. A second food leaking hole 237 that corresponds to the first food leaking hole 234 is provided in the rotation plate 235. An annular groove is provided in an outer edge of the partition plate 233. The rotation plate 235 is rotationally disposed in the annular groove. A diameter of the rotation plate 235 is greater than or equal to a diameter of the discharge frame 211 and less than a diameter of the annular groove. When the diameter of the rotation plate 235 is greater than the diameter of the discharge frame 211 and less than the diameter of the annular groove and the motor 231 rotates, the output shaft drives the rotation plate 235 to rotate in the annular groove. When the second food leaking hole 237 of the rotation plate 235 overlaps the first food leaking hole 234 of the partition plate 233, the pet food falls out of the accommodating bucket 4. When the motor 231 continues to rotate, the second food leaking hole 237 and the first food leaking hole 234 are staggered, so that the pet food stops falling. In this embodiment, a mounting sleeve 236 is provided on the rotation plate 235, and the output shaft of the motor 231 and the mounting sleeve 236 on the rotation plate 235 are assembled in a clamped manner, so that the motor 231 and the rotation plate 235 are convenient to detach. A fastening rod 232 for fastening the motor 231 is disposed at the bottom of the partition plate 233.

The working principle of the present invention is generally described as follows: The discharge assembly 2 communicates with the accommodating bucket 4. The discharge assembly 2 is configured to control food in the accommodating bucket 4 to fall or stop falling. A plurality of expansion buckets 5 are provided. Clamping slots 41 are provided on the tops of the expansion buckets 5 and the top of the accommodating bucket 4. One detachment member is disposed at each of joints of adjacent expansion buckets 5 and the accommodating bucket 4. The detachment member includes a clamping block 51 and the clamping slot 41 for clamping the clamping block 51. The clamping blocks 51 are disposed at the bottom of the expansion bucket 5. Between the expansion buckets 5 or between the expansion bucket 5 and the accommodating bucket 4, through the cooperation of the clamping blocks 51 and the clamping slots 41, the expansion buckets 5 communicate with the accommodating bucket 4, so that the expansion buckets 5 are detachably stacked at an end of the accommodating bucket 4 away from the discharge assembly 2, to implement an expansion function. With such an arrangement, the variable-capacity pet feeder effectively resolves the defect that existing pet feeders generally have an invariable capacity, so that a user can only buy an invariable-capacity pet feeder and store pet food in the invariable-capacity pet feeder during use, causing inconvenience of food storage, and has the advantages of having an arbitrarily variable feeder capacity, facilitating food storage convenience, and being easy to change, simple and practical.

The foregoing is merely used to describe the technical solutions of the present invention but does not constitute any limitation. Other modifications or equivalent replacements made to the technical solutions of the present invention by a person of ordinary skill in the art shall all fall within the scope of the claims of the present invention without departing from the spirits and scope of the technical solutions of the present invention.

What is claimed is:

1. A variable-capacity pet feeder, comprising:
an accommodating bucket (4);
a discharge assembly (2), wherein the discharge assembly (2) communicates with the accommodating bucket (4); and
expansion buckets (5), wherein a plurality of expansion buckets (5) are provided, the plurality of expansion buckets (5) are disposed at an end of the accommodating bucket (4) away from the discharge assembly (2), and the expansion buckets (5) communicate with the accommodating bucket (4).

2. The variable-capacity pet feeder according to claim 1, wherein one detachment member is disposed at each of joints of adjacent expansion buckets (5) and the accommodating bucket (4).

3. The variable-capacity pet feeder according to claim 2, wherein the detachment member comprises a clamping block (51) and a clamping slot (41) for clamping the clamping block (51).

4. The variable-capacity pet feeder according to claim 1, wherein the discharge assembly (2) comprises:
a food guide base (21), wherein the food guide base (21) is disposed at the bottom of the accommodating bucket (4); and
a discharge member, wherein the discharge member is disposed in the food guide base (21), a discharge frame (211) communicating with the accommodating bucket (4) is disposed on the discharge member, and the discharge member is configured to control food in the accommodating bucket (4) to fall or stop falling.

5. The variable-capacity pet feeder according to claim 1, wherein a connector (3) is disposed between the discharge assembly (2) and the accommodating bucket (4).

6. The variable-capacity pet feeder according to claim 4, wherein the discharge member comprises:
a partition plate (233), wherein the partition plate is fixedly disposed in the food guide base (21), and a first food leaking hole (234) and a through-hole are provided in the partition plate (233);
a motor (231) fixedly disposed at the bottom of the partition plate (233), wherein an output shaft of the motor (231) penetrates through the through-hole; and
a rotation plate (235), wherein one side of the rotation plate (235) is fixedly disposed at an end of the discharge frame (211) away from the accommodating bucket (4), the other side of the rotation plate (235) is closely attached to the partition plate (233), the rotation plate (235) is connected to the output shaft of the motor (231), a second food leaking hole (237) that corresponds to the first food leaking hole (234) is provided in the rotation plate (235), an annular groove is provided in an outer edge of the partition plate (233), the rotation plate (235) is rotationally disposed in the annular groove, and a diameter of the rotation plate (235) is greater than or equal to a diameter of the discharge frame (211) and less than a diameter of the annular groove.

7. The variable-capacity pet feeder according to claim 6, wherein the output shaft of the motor (231) and the rotation plate (235) are detachably assembled.

8. The variable-capacity pet feeder according to claim 1, wherein an upper cover (6) is disposed at the top of the accommodating bucket (4) or on the expansion bucket (5).

9. The variable-capacity pet feeder according to claim 4, wherein a food dish (1) is disposed on a side of the food guide base (21), a food guide plate (22) is disposed on a side face of the food guide base (21), one end of the food guide plate (22) is disposed below a discharge portion of the discharge assembly (2), and the other end of the food guide plate (22) is disposed above the food dish (1).

10. The variable-capacity pet feeder according to claim 9, wherein the food dish (1) and the food guide base (21) are detachably assembled.
